(19) United States
(12) Patent Application Publication
(10) Pub. No.: US 2015/0085721 A1
(43) Pub. Date: Mar. 26, 2015

(54) METHOD AND APPARATUS FOR ENHANCING UL HARQ PROCESS

(71) Applicant: HTC Corporation, Taoyuan County (TW)

(72) Inventor: Ling-San MENG, Taoyuan County (TW)

(21) Appl. No.: 14/497,339

(22) Filed: Sep. 26, 2014

Related U.S. Application Data
(60) Provisional application No. 61/883,170, filed on Sep. 26, 2013.

(51) Int. Cl. H04L 1/18; H04L 5/00; H04W 72/14; H04W 72/04; H04L 12/18; H04L 5/14

(52) U.S. Cl. CPC H04L 1/1887; H04L 12/189; H04L 5/14; H04W 72/14; H04W 72/042; H04L 5/0092
USPC 370/280

(57) ABSTRACT

A method for determining an uplink hybrid automatic repeat request (UL HARQ) timeline of a time-division duplex (TDD) uplink-downlink (UL-DL) configuration is disclosed herein. The method for determining the UL HARQ timeline includes the following steps: allocating a subframe of the TDD UL-DL configuration for transmission of an UL HARQ ACK/NACK message or of an UL grant message; and forming an equivalent uplink subframe from a downlink subframe by configuring the downlink subframe as a multicast-broadcast single frequency network (MBSFN) subframe or from a special subframe in the TDD UL-DL configuration for transmission of data in response to the UL HARQ NACK message or to the UL grant message.

### RELATED APPLICATIONS

This application claims the priority benefit of U.S. Provisional Application Ser. No. 61/883,170 filed Sep. 26, 2013, which is herein incorporated by reference.

### BACKGROUND

1. Field of Invention

The present disclosure relates to a method for determining an uplink hybrid automatic repeat request (UL HARQ) timeline. More particularly, the present disclosure relates to a method for determining the UL HARQ timeline of a time-division duplex (TDD) uplink-downlink (UL-DL) configuration according to a multicast-broadcast single frequency network (MBSFN) frame or to a special subframe.

2. Description of Related Art

Time division duplex (TDD) offers flexible deployments without requiring a pair of spectrum resources. Currently, Long Term Evolution (LTE) TDD allows for asymmetric downlink-uplink (DL-UL) allocations by providing seven different semi-statically configured DL-UL configurations.

The current mechanism for adapting DL-UL allocation is based on the system information change procedure. Additional mechanisms could include dynamic allocation of subframes to UL or to DL. Compared with the system information change procedure, the dynamic mechanisms allow a much shorter period for TDD DL-UL reconfiguration. Such an idea is termed “Further Enhancements to LTE TDD for DL-UL Interference Management and Traffic Adaptation” (eIMTA) in 3GPP. Allowing TDD DL-UL reconfiguration based on traffic adaptation brings the significant performance benefits in small cells. Furthermore, dynamic signaling mechanisms outperform that using the system information change procedure.

Although the TDD uplink-downlink configuration could be switched dynamically, the flexibility of current mechanisms is still not enough for adapting the traffic that varies dramatically. Therefore, there is a need to increase the flexibility in the TDD configurations.

### SUMMARY

The disclosure provides a method for determining an uplink hybrid automatic repeat request (UL HARQ) timeline of a time-division duplex (TDD) uplink-downlink (UL-DL) configuration. The method for determining the UL HARQ timeline includes the following steps: allocating a subframe of the TDD UL-DL configuration for transmission of an UL HARQ ACK/NACK message or an UL grant message; and forming an equivalent uplink subframe from a downlink subframe by configuring the downlink subframe as a multicast-broadcast single frequency network (MBSFN) subframe or from a special subframe in the current TDD UL-DL configuration for transmission of data in response to the UL HARQ NACK message or to the UL grant message.

The disclosure provides an apparatus for wireless communication. The apparatus includes a processing module and a storage module. The storage module includes a time-division duplex (TDD) uplink-downlink (UL-DL) configuration for a uplink hybrid automatic repeat request (UL HARQ) process and one or more sequences of instructions to be executed by the processing module to perform: receiving an UL HARQ ACK/NACK message or an UL grant message in a subframe of the TDD UL-DL configuration; and in response to the UL HARQ NACK message or to the UL grant message, transmitting data in a downlink subframe configured as a multicast-broadcast single frequency network (MBSFN) subframe or in a special subframe of the TDD UL-DL configuration.

The disclosure provides an apparatus for wireless communication. The apparatus includes a processing module and a storage module. The storage module includes a time-division duplex (TDD) uplink-downlink (UL-DL) configuration for an uplink hybrid automatic repeat request (UL HARQ) process and one or more sequences of instructions to be executed by the processing module to perform: transmitting an UL HARQ ACK/NACK message or an UL grant message in a subframe of the TDD UL-DL configuration; and receiving data in response to the UL HARQ NACK message or to the UL grant message in a downlink subframe configured as a multicast-broadcast single frequency network (MBSFN) subframe or in a special subframe of the TDD UL-DL configuration.

It is to be understood that both the foregoing general description and the following detailed description are by examples, and are intended to provide further explanation of the disclosed as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic diagram illustrating uplink hybrid automatic repeat request (UL HARQ) timelines of seven time-division duplex (TDD) uplink-downlink (UL-DL) configurations in a Long Term Evolution (LTE) TDD communication system;

FIG. 1B is a table illustrating the relationship between the UL HARQ ACK/NACK message and the corresponding uplink retransmission;

FIG. 2A is a schematic diagram illustrating a modified TDD UL-DL configuration 1 according to one embodiment of this disclosure;

FIG. 2B is a table illustrating the relationship between the UL HARQ ACK/NACK message and the corresponding uplink retransmission according to one embodiment of this disclosure;

FIG. 3A is a schematic diagram illustrating a modified TDD UL-DL configuration 1 according to one embodiment of this disclosure;

FIG. 3B is a table illustrating the relationship between the UL HARQ ACK/NACK message and the corresponding uplink retransmission according to one embodiment of this disclosure;

FIG. 4 is a flow diagram illustrating the method for determining an UL HARQ timeline of a TDD UL-DL configuration according to one embodiment of this disclosure; and

FIGS. 5 is a schematic diagram illustrating a wireless communication system according to one embodiment of this disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

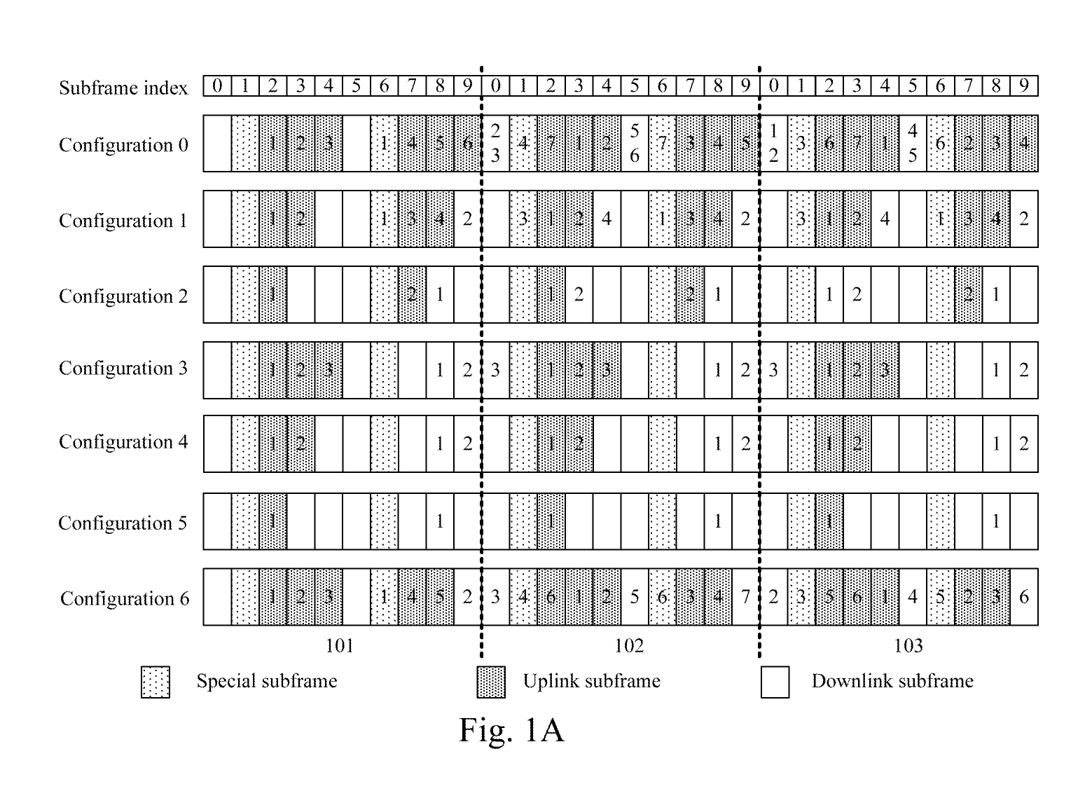

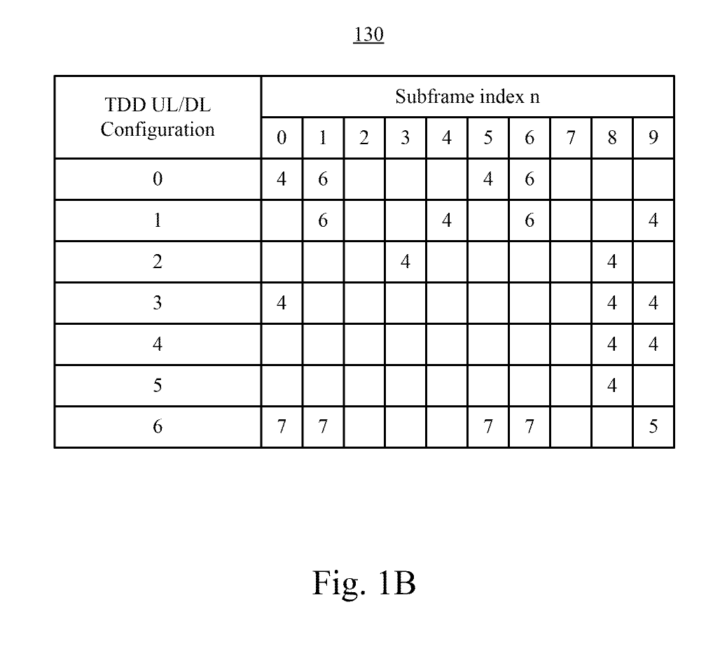

Referring to FIG. 1A, a schematic diagram which illustrates uplink hybrid automatic repeat request (UL HARQ) timelines of seven time-division duplex (TDD) uplink-downlink (UL-DL) configurations in a Long Term Evolution (LTE) TDD communication system is presented. Each of the seven TDD UL-DL configurations shown in FIG. 1A takes three radio frames 101-103 as an example, but it is not limited thereto. Each of the radio frames 101-103 includes 10 subframes, e.g., special subframes, uplink subframes and downlink subframes. The number in the subframe corresponds to the index for an UL HARQ process. For example, in configuration 5, the uplink data transmission takes place in subframe 2 (index for UL HARQ process: 1) of the radio frame 101, in which the subframe 2 corresponds to the subframe with a subframe index 2. When the uplink data is not successfully received by a serving base station, the serving base station transmits an UL HARQ NACK message back in subframe 8 (index for UL HARQ process: 1). Subsequently, the uplink data retransmission takes place in subframe 2 (index for UL HARQ process: 1) of the radio frame 102, and so forth.

In a TDD system for LTE, UL HARQ would be implemented in a different manner from a FDD system where an HARQ ACK/NACK message in response to a transmission on a subframe would occur at a relatively fixed interval. However, for a TDD system, the UL HARQ ACK/NACK message in response to a transmission on a subframe would not occur at a fixed interval because of the variable numbers of uplink subframes and downlink subframes for different TDD configurations. In general, when a downlink subframe has been used to receive downlink data, a next uplink subframe which is at least four subframes away would be used to transmit the HARQ ACK/NACK message, and vice versa. The four subframes delay is due to the processing delay of the receiving end.

For example, in the configuration 1 shown in FIG. 1A, when a first uplink data is transmitted by an user equipment (UE) in the subframe 2 of radio frame N, e.g., N=1, the corresponding UL HARQ ACK/NACK message would be received by the same UE in the subframe 6, which is 4 subframes away from the subframe 2, of radio frame N. Similarly when a second uplink data is transmitted in the subframe 3 of radio frame N, the corresponding UL HARQ ACK/NACK message would be received in the subframe 9, which is 6 subframes away from the subframe 3, of radio frame N. When the UL HARQ ACK/NACK message is received by the UE in the subframe 6, the corresponding retransmission would be transmitted by the UE in the subframe 2 of radio frame N+1, and so forth. When the UL HARQ ACK/NACK message is received by the UE at subframe 9, the corresponding retransmission would be transmitted by the UE at subframe 3 of radio frame N+1, and so forth. Therefore, the next uplink subframe is at least four subframes away from the subframe corresponding to the UL HARQ ACK/NACK message.

Since the legacy UEs and the eIMTA UEs might have a different understanding of the current TDD DL-UL configuration, it would be noted that if a downlink subframe is dynamically changed to an uplink subframe for the eIMTA UE, the legacy UEs obtain incorrect downlink channel quality measurement. The reason is that when the eIMTA UE transmits uplink data to the serving base station, the uplink data may be introduced to the other legacy UEs as interference since the legacy UEs are configured to receive data. However, if an uplink subframe is dynamically changed to a downlink subframe, no interference is introduced. The reason is that a serving base station of the UEs would have control over when the UEs suppose to transmit uplink data to the serving base station. In other words, no interference is introduced to the other UEs since the serving base station could control the UEs not to transmit uplink data in the UL subframes. Therefore, no uplink data interferes with the downlink data transmitted in the downlink subframe which is changed from the uplink subframe.

Referring also to FIG. 1B, a table 130 illustrating the relationship between the UL HARQ ACK/NACK message and the uplink retransmission from another perspective is presented. Table 130 is a lookup table for deciding a subframe for the UL retransmission when an UL HARQ ACK/NACK message is received. That is to say, when an UL HARQ NACK message is received in subframe n, the UL transmission in response to the UL HARQ NACK message is in subframe n+k, in which k is the number in table 130. Take TDD UL/DL configuration 1 as an example, when an UL HARQ NACK message is received by the UE in subframe 1, the corresponding uplink retransmission is in subframe 7, in which the number “7” is obtained by n+k, i.e., 1+6. For another example, when an UL grant message is received in subframe 4, the corresponding UL transmission is in subframe 8, in which the number “8” is also obtained by n+k, i.e., 4+4.

In some embodiments, the UL HARQ ACK/NACK message and the uplink retransmission could be an uplink grant message and an uplink transmission respectively.

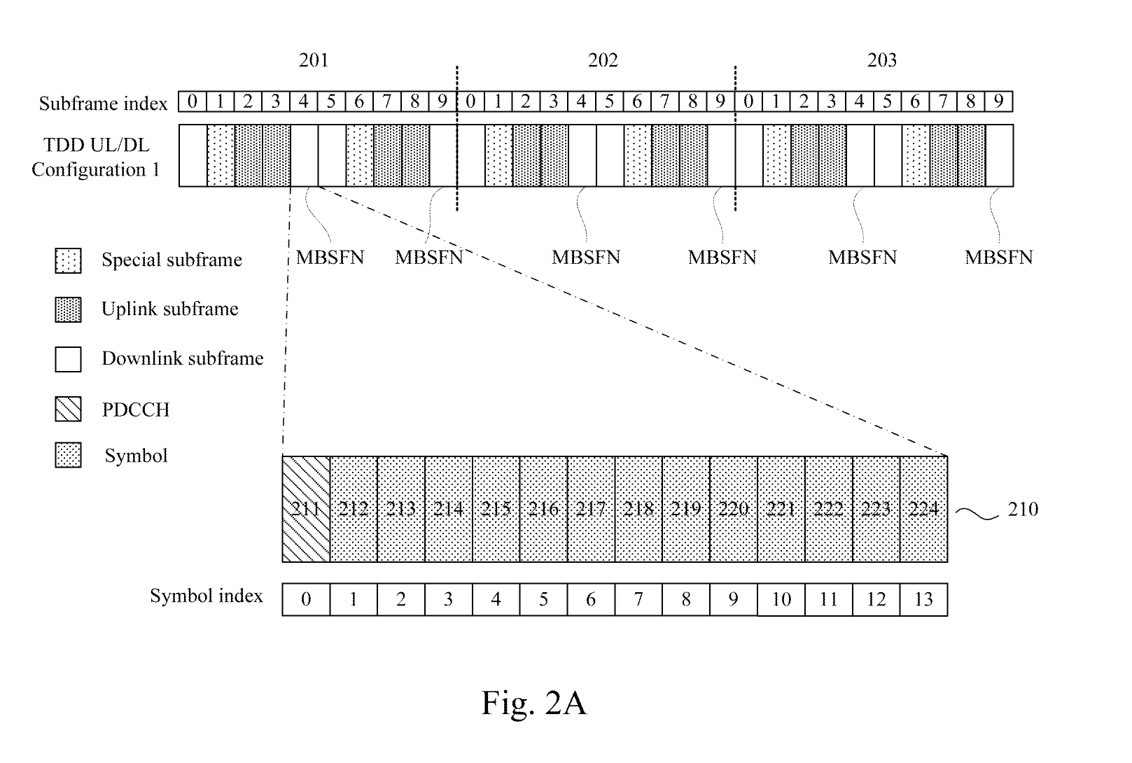

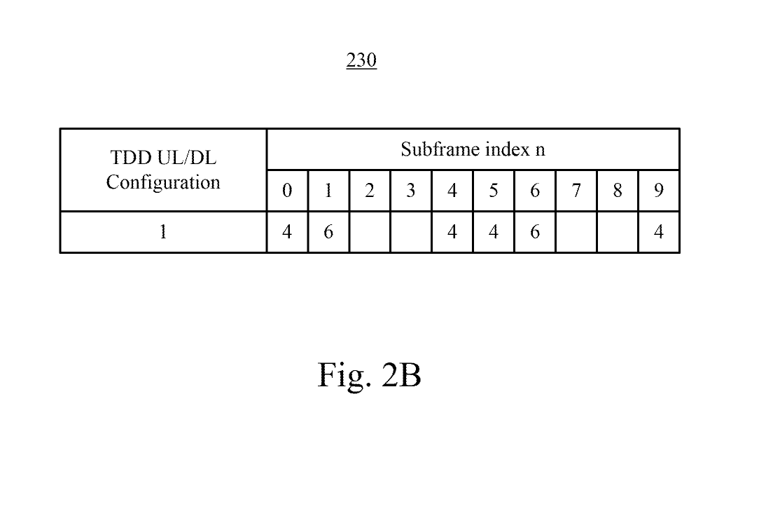

In order to preserve backward compatibility and allow legacy user equipments (UEs) to perform downlink signal quality measurement, downlink subframes configured as multicast-broadcast single frequency network (MBSFN) subframes can be utilized such that the legacy UEs only monitor PDCCH of the MBSFN subframes. The remaining symbols in the downlink subframe corresponding to the MBSFN can then be utilized to perform UL transmission for eIMTA UEs. The LTE TDD radio frame structure and the DL-UL configuration are defined in FIG. 2A.

Referring to FIG. 2A, a schematic diagram illustrating a modified TDD UL-DL configuration 1 according to one embodiment of this disclosure is presented. Each of radio frames 201-203 in the modified TDD UL/DL configuration 1 has 10 subframes, in which the subframes includes a plurality of special subframes, uplink subframes and downlink subframes. Each subframe includes 14 symbols. The subframe 4 and the subframe 9 of the radio frames 201-203 are originally DL subframes. In the present embodiment, the downlink subframes 4 and 9 are configured as MBSFN subframes.

Take the downlink subframe 4 of the radio frame 201 as an example, the downlink subframe 4 is configured as the MBSFN subframe 210 in the present embodiment. The MBSFN subframe 210 includes symbols 211-224, in which the symbol 211 is for PDCCH signaling, and the symbols 212-224 are for broadcasting signals. It should be noted that the MBSFN subframe 210 could be configured such that the legacy UEs only monitors the symbol 211 for the PDCCH signals. The remaining symbols 212-224 can be used by the eIMTA UEs for uplink transmission of data. Therefore, the subframe 4 can be utilized as an equivalent uplink subframe. Similar to those mentioned above, the subframe 9 can also be utilized as another equivalent uplink subframe if the subframe 9 is configured as a MBSFN subframe.

Referring also to FIG. 2B, a table 230 illustrating the relationship between the UL HARQ ACK/NACK message and the uplink retransmission is presented. Compared to TDD UL/DL configuration 1 of table 130 in FIG. 1B, the TDD UL/DL configuration 1 in the table 230 has two more numbers corresponding to the subframe 0 and subframe 5. In other words, the TDD UL/DL configuration 1 in the table 230 have more subframes to perform the UL HARQ process, which makes the UL HARQ process more flexible. In more details, when HARQ ACK/NACK message or an uplink grant message is received in subframe 0 or in subframe 5, the TDD UL/DL configuration 1 provides an equivalent uplink frame for uplink retransmission of data in response to the UL HARQ NACK message or for uplink transmission of data in response to the UL grant message, in which the equivalent uplink subframe is the MBSFN subframe. For example, when an UL HARQ NACK message is received in subframe 0, i.e., a downlink subframe, data in response to the UL HARQ NACK message is transmitted in the subframe 4, i.e., 0+4, in which subframe 4 is the MBSFN subframe.

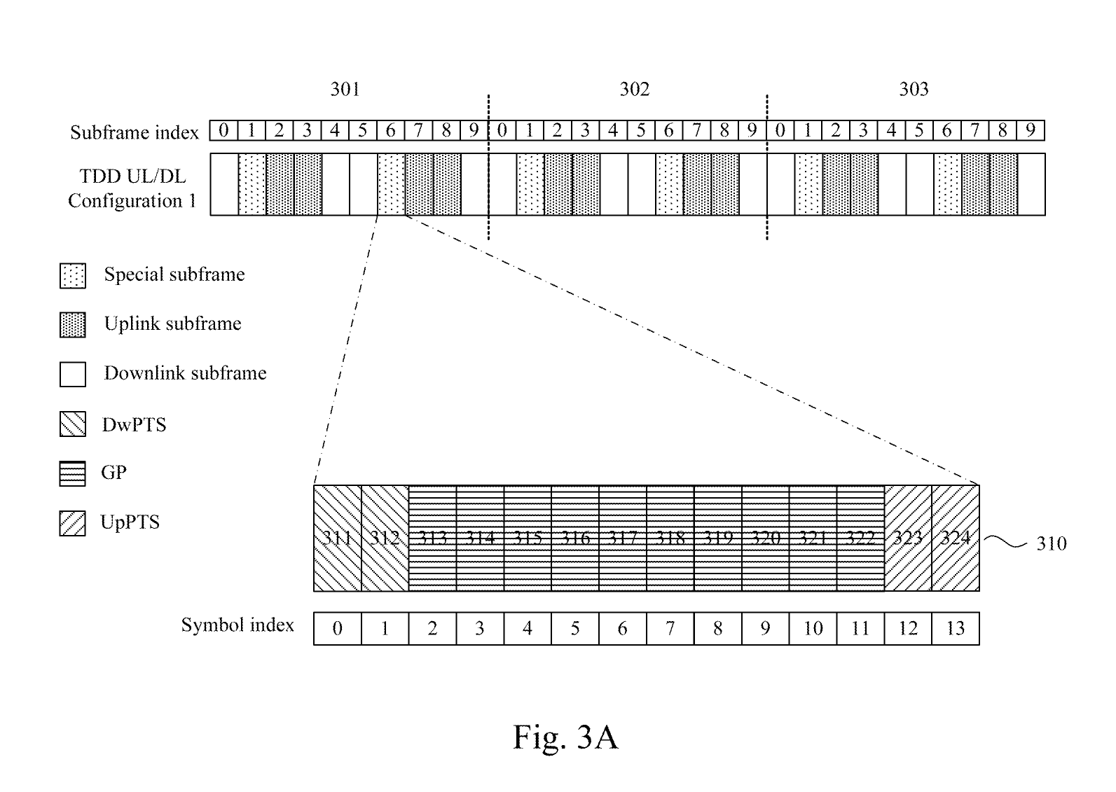

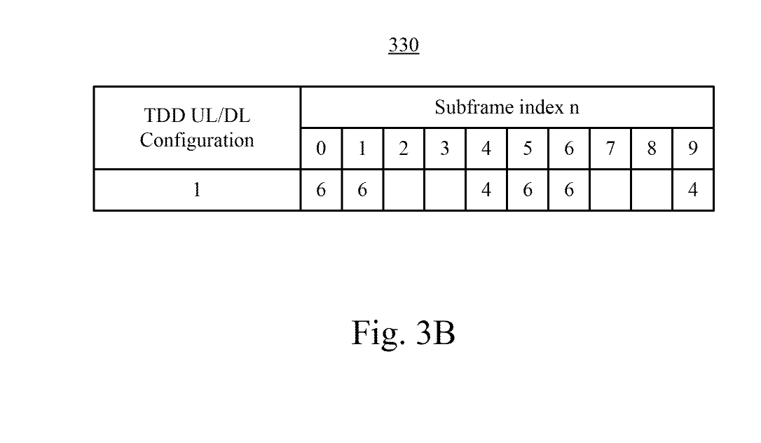

Alternatively, the special subframes can also be utilized for eIMTA UEs to perform uplink transmission. Referring to FIG. 3A, a schematic diagram illustrating a modified TDD UL/DL configuration 1 according to one embodiment of this disclosure is presented. Each of the radio frames 301-303 includes 10 subframes, and each subframe includes 14 symbols. In the present embodiment, the special subframes, i.e., the subframe 1 and the subframe 6 of each radio frame 301-303 are utilized to perform an equivalent uplink transmission.

In more details, take subframe 6, i.e., the special subframe, of the radio frame 301 as an example, the special subframe includes 14 symbols 311-324, in which the symbols 311-312 are utilized for downlink pilot time slot (DwPTS), the symbols 313-322 are utilized for guard period (GP), and symbols 323-324 are utilized for uplink pilot time slot (UpPTS) in the present embodiment. However, numbers of symbols corresponding to the DwPTS, the GP and the UpPTS respectively can be configured by the base station; therefore, the numbers of symbols corresponding to the DwPTS, the GP and the UpPTS respectively are not limited thereto. Since no data is transmitted in the GP in the original configuration, the uplink transmission of the data can be allocated in the GP in the present embodiment. Therefore, the subframe 6, i.e., the special subframe, can be utilized as an equivalent uplink subframe. Similar to those mentioned above, the subframe 1, i.e., the special subframe, can also be utilized as an equivalent uplink subframe.

In some embodiments, one symbol (e.g. symbol 313) of the GP is not utilized for the uplink transmission since the symbol (e.g. symbol 313) of the GP is utilized to avoid the interference caused by the downlink transmission in the DwPTS. In other words, no data is transmitted in one symbol (e.g. symbol 313) of the GP.

In some embodiments, multiple symbols (e.g. the symbols 313-315) are not utilized for the uplink transmission so as to avoid the interference caused by the downlink transmission in the DwPTS. In other words, no data is transmitted in multiple symbol (e.g. symbols 313-315) of the GP.

In some embodiments, the uplink transmission of the data in response to the UL HARQ NACK message or to the UL grant message takes place in both the GP and the UpPTS.

In some embodiments, the last symbol 324 of the UpPTS may be configured for a transmission of a sounding reference signal (SRS), in which the SRS is for channel estimation of uplink channels. However, the transmission of the SRS is configured by the base station. In other words, the base station may signal to the legacy UEs such that the legacy UEs would not transmit the SRS. Therefore, all symbols of the UpPTS can be utilized to perform an equivalent uplink transmission by the eIMTA UEs.

Referring also to FIG. 3B, a table 330 illustrating the relationship between the UL HARQ ACK/NACK message and the uplink retransmission is presented. Compared to TDD UL/DL configuration 1 of table 130 in FIG. 1B, the TDD UL/DL configuration 1 in the table 330 has two more numbers corresponding to the subframe 0 and subframe 5. In other words, the TDD UL/DL configuration 1 in the table 330 have more subframes to perform the UL HARQ process, which makes the UL HARQ process more flexible. In more details, when an UL HARQ ACK/NACK message or an UL grant message is received in subframe 0 or in subframe 5, the TDD UL/DL configuration 1 provides an equivalent uplink frame for uplink retransmission of data in response to the UL HARQ NACK message or for uplink transmission of data in response to the UL grant message, in which the equivalent uplink subframe is the special subframe.

For example, when an UL HARQ NACK message is received in the subframe 0, i.e., a downlink subframe, the data in response to the UL HARQ NACK message is transmitted in the subframe 6, i.e., 0+6, in which the subframe 6 is the special subframe.

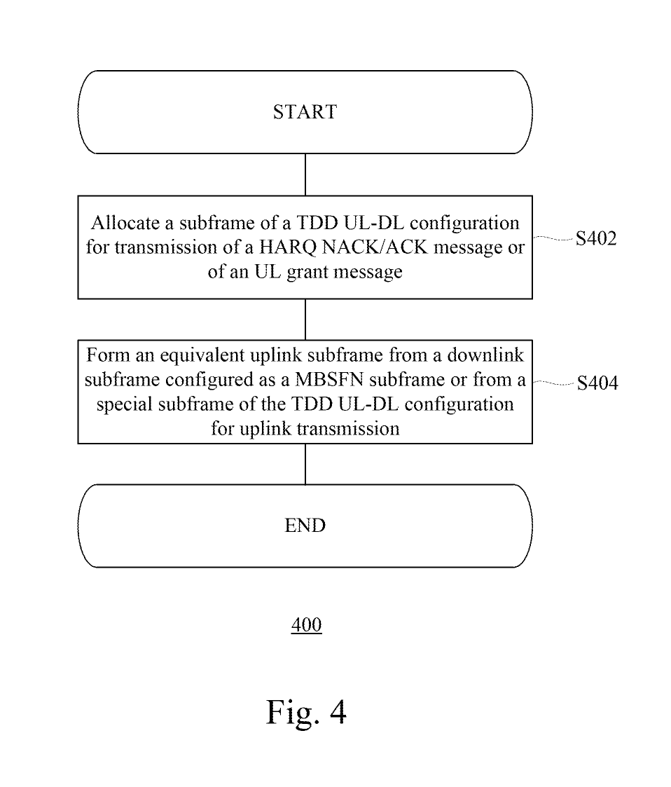

Referring to FIG. 4, a flow diagram illustrating the method 400 for determining an UL HARQ timeline of a TDD UL-DL configuration is presented. The method 400 is configured to add more equivalent uplink subframes in the TDD UL-DL configuration.

In step S402, a subframe of the TDD UL-DL configuration is allocated for transmission of an UL HARQ ACK/NACK message or of an UL grant message.

In some embodiments, the subframe of the TDD UL-DL configuration in the step S402 may be a downlink subframe or a special subframe.

In step S404, an equivalent uplink subframe is formed from a downlink subframe by configuring the downlink subframe as a MBSFN frame or a special subframe in the TDD UL-DL configuration, in which the equivalent uplink subframe is utilized for uplink transmission in response to the UL HARQ NACK message or to the UL grant message.

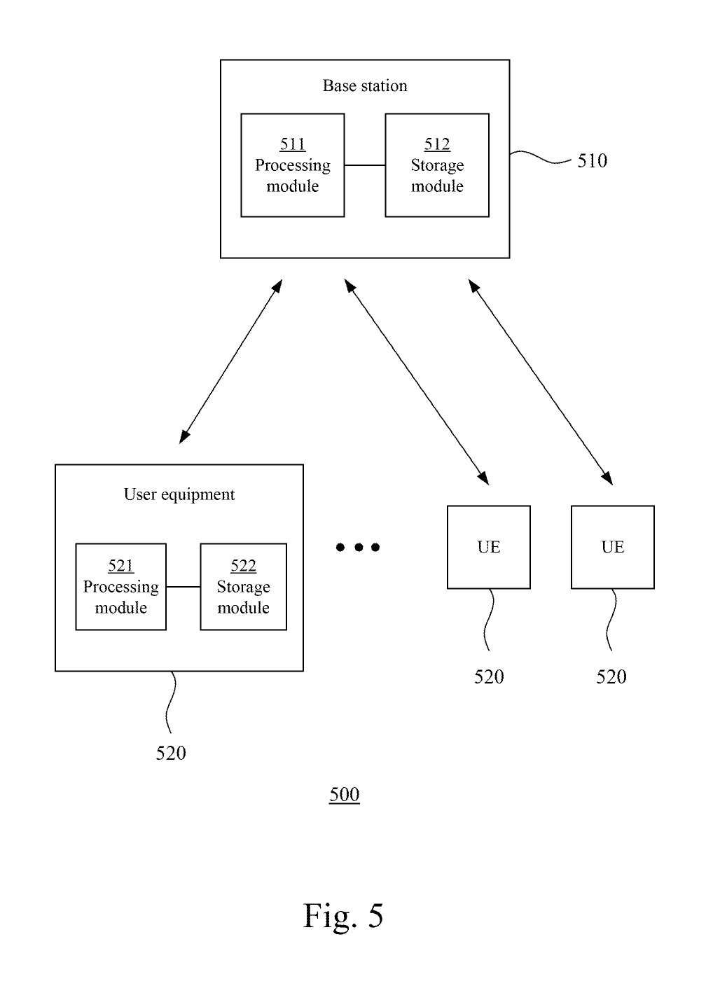

Referring to FIG. 5, a schematic diagram illustrating a wireless communication system 500 according to one embodiment of this disclosure is presented. In the present embodiment, the wireless communication system 500 is an LTE TDD system, but it is not limited thereto. The wireless communication system 500 includes a base station 510, i.e., an eNodeB, and a plurality of UEs 520, in which the base station 510 serves the UEs 520.

In some embodiments, the UEs can be mobile phones, tablets, computer systems, etc.

The base station 510 includes a processing module 511 and a storage module 512. The storage module 512 stores at least one TDD UL-DL configuration, e.g., TDD UL-DL configuration 1, for the UL HARQ process and one or more sequences of instructions to be executed by the processing module 512 to perform the following steps.

First, the base station 510 transmits an UL HARQ ACK/NACK message or an UL grant message in a subframe of the TDD UL-DL configuration. Subsequently, the base station 510 receives data in response to the UL HARQ NACK message or to the UL grant message in a downlink subframe configures as a MBSFN frame or in a special subframe of the TDD UL-DL configuration.

Each of the UEs 520 includes a processing module 521 and a storage module 522. The storage module 522 stores the TDD UL-DL configuration for the UL HARQ process and one or more sequences of instructions to be executed by the processing module 521 to perform the following steps.

First, the UE 520 receives an UL HARQ ACK/NACK message or an UL grant message in a subframe of the TDD UL-DL configuration. Subsequently, the UE 520 transmits data in response to the UL HARQ NACK message or to the UL grant message in a downlink subframe configured as a MBSFN frame or a special subframe of the TDD UL-DL configuration.

In some embodiments, the processing module 511 and the processing module 512 may be a central processing unit or a processor respectively.

In some embodiments, the storage module 512 and the storage 522 may respectively be non-volatile memory such as read only memory (ROM), programmable read only memory (PROM), erasable programmable read only memory (EPROM), and electrically erasable programmable read only memory (EEPROM) devices, volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs), and magnetic storage devices such as hard disk drives (HDD) and floppy disk drives.

Based on the aforesaid embodiments, the method for determining an UL HARQ timeline of a TDD UL-DL configuration increases the number of uplink subframes, i.e., the uplink frames and the equivalent uplink frames, for data retransmission or data transmission. Moreover, the UL HARQ timeline proposed in the present disclosure also avoids the interference caused by the dynamic configurations of eIMTA UEs to the legacy UEs.

It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A method for determining an uplink hybrid automatic repeat request (UL HARQ) timeline of a time-division duplex (TDD) uplink-downlink (UL-DL) configuration, comprising:
allocating a subframe of the TDD UL-DL configuration for transmission of an UL HARQ ACK/NACK message or an UL grant message; and
forming an equivalent uplink subframe from a downlink subframe by configuring the downlink subframe as a multicast-broadcast single frequency network (MBSFN) subframe or from a special subframe in the TDD UL-DL configuration, for transmission of data in response to the HARQ NACK message or to the UL grant message.

2. The method of claim 1, wherein the equivalent uplink subframe corresponding to the MBSFN subframe includes a physical downlink control channel (PDCCH), and the data in response to the UL HARQ NACK message or to the UL grant message is transmitted after the PDCCH in the equivalent uplink subframe corresponding to the MBSFN subframe.

3. The method of claim 1, wherein the TDD UL-DL configuration is TDD UL-DL configuration 1 and includes subframes 0-9, the transmission of the UL HARQ ACK/NACK message or of the UL grant message is allocated in the subframe 0 or in the subframe 5, and the transmission of data in response to the UL HARQ NACK message or to the UL grant message is allocated in the subframe 4 or in the subframe 9, in which the subframe 4 and the subframe 9 are the downlink subframes configured as the MBFSN frames.

4. The method of claim 1, wherein the equivalent uplink subframe corresponding to the special subframe includes a downlink pilot time slot, a guard period and an uplink pilot time slot, and the data in response to the UL HARQ NACK message or to the UL grant message is transmitted in the guard period.

5. The method of claim 1, wherein the equivalent uplink subframe corresponding to the special subframe includes a downlink pilot time slot, a guard period and an uplink pilot time slot, and the data in response to the UL HARQ NACK message or to the UL grant message is transmitted in both the guard period and the uplink time slot.

6. The method of claim 1, wherein the TDD UL-DL configuration is TDD UL-DL configuration 1 and includes subframes 0-9, the transmission of the UL HARQ ACK/NACK message or of the UL grant message is allocated in the subframe 0 or in the subframe 5, and the transmission of the data in response to the UL HARQ NACK message or to the UL grant message is allocated in the subframe 1 or in the subframe 6, in which the subframe 1 and the subframe 6 are the special subframes.

7. An apparatus for wireless communication, comprising:
a processing module; and
a storage module comprising a time-division duplex (TDD) uplink-downlink (UL-DL) configuration for an uplink hybrid automatic repeat request (UL HARQ) process and one or more sequences of instructions to be executed by the processing module to perform:
receiving an UL HARQ ACK/NACK message or an UL grant message in a subframe of the TDD UL-DL configuration; and
in response to the UL HARQ NACK message or to the UL grant message, transmitting data in a downlink subframe configured as a multicast-broadcast single frequency network (MBSFN) subframe or in a special subframe of the TDD UL-DL configuration.

8. The apparatus of claim 7, wherein the downlink subframe configured as the MBSFN frame includes a physical downlink control channel (PDCCH), and the step of transmitting the data further comprises:
in response to the UL HARQ NACK message or to the UL grant message, transmitting the data after the PDCCH in the downlink subframe configured as the MBSFN frame.

9. The apparatus of claim 7, wherein the special subframe includes a downlink pilot time slot, a guard period and an uplink pilot time slot, and the step of transmitting the data comprises:
in response to the UL HARQ NACK message or to the UL grant message, transmitting the data in the guard period.

10. The apparatus of claim 7, wherein the special subframe includes a downlink pilot time slot, a guard period and an uplink pilot time slot, and the step of transmitting the data comprises:
in response to the UL HARQ NACK message or to the UL grant message, transmitting the data in both the guard period and the uplink time slot.

11. The apparatus of claim 7, wherein the TDD UL-DL configuration is TDD UL-DL configuration 1 and includes subframes 0-9, the step of receiving the UL HARQ ACK/NACK message or the UL grant message further comprises:
receiving the UL HARQ ACK/NACK message or the UL grant message in the subframe 0 or in the subframe 5.

12. The apparatus of claim 11, the step of transmitting the data comprises:
transmitting the data in response to the UL HARQ NACK message or to the UL grant message in the subframe 4 or in the subframe 9, in which the subframe 4 and the subframe 9 are downlink subframes configured as the MBFSN frames.

13. The apparatus of claim 11, the step of transmitting the data comprises:
transmitting the data in response to the UL HARQ NACK message or to the UL grant message in the subframe 1 or in the subframe 6, in which the subframe 1 and the subframe 6 are the special subframes.

14. An apparatus for wireless communication, comprising:
a processing module; and
a storage module comprising a time-division duplex (TDD) uplink-downlink (UL-DL) configuration for a uplink hybrid automatic repeat request (UL HARQ) process and one or more sequences of instructions to be executed by the processing module to perform:
transmitting an UL HARQ ACK/NACK message or an UL grant message in a subframe of the TDD UL-DL configuration; and
receiving data in response to the UL HARQ NACK message or to the UL grant message in a downlink subframe configured as a multicast-broadcast single frequency network (MBSFN) subframe or in a special subframe of the TDD UL-DL configuration.

15. The apparatus of claim 14, wherein the downlink subframe configured as the MBSFN frame includes a physical downlink control channel (PDCCH), and the step of receiving the data further comprises:
receiving the data in response to the UL HARQ NACK message or to the UL grant message after the PDCCH in the downlink subframe configured as the MBSFN frame.

16. The apparatus of claim 14, wherein the special subframe includes a downlink pilot time slot, a guard period and an uplink pilot time slot, and the step of receiving the data comprises:
receiving the data in response to the UL HARQ NACK message or to the UL grant message in the guard period.

17. The apparatus of claim 14, wherein the special subframe includes a downlink pilot time slot, a guard period and an uplink pilot time slot, and the step of receiving the data comprises:
receiving the data in response to the UL HARQ NACK message or to the UL grant message in both the guard period and the uplink time slot.

18. The apparatus of claim 14, wherein the TDD UL-DL configuration is TDD configuration 1 and includes subframes 0-9, and the step of transmitting the UL HARQ ACK/NACK message or the UL grant message further comprises:
transmitting the UL HARQ ACK/NACK message or the UL grant message in the subframe 0 or in the subframe 5.

19. The apparatus of claim 18, wherein the step of receiving the data comprises:
receiving the data in response to the UL HARQ NACK message or to the UL grant message in the subframe 4 or in the subframe 9, in which the subframe 4 and the subframe 9 are downlink subframes configured as the MBFSN frames.

20. The apparatus of claim 11, the step of receiving the data comprises:
receiving the data in response to the UL HARQ NACK message or to the UL grant message in the subframe 1 or in the subframe 6, in which the subframe 1 and the subframe 6 are the special subframes.
